(19) United States
(12) Patent Application Publication
(10) Pub. No.: US 2025/0232721 A1
(43) Pub. Date: Jul. 17, 2025

(54) DISPLAY DEVICE

(71) Applicant: Sharp Display Technology Corporation, Kameyama City, Mie (JP)

(72) Inventor: Hidekazu MIYATA, Kameyama City, Mie (JP)

(21) Appl. No.: 18/700,479

(22) PCT Filed: Jan. 24, 2022
(86) PCT No.: PCT/JP2022/002447

§ 371 Date: Apr. 11, 2024

(51) Int. Cl. G09G 3/3233

(52) U.S. Cl. CPC G09G 3/3233; G09G 2300/043

(57) ABSTRACT

A first capacitor has: a first electrode connected to a gate terminal of a drive transistor and to a write control transistor; and a second electrode connected to a constant potential wire, such that a data signal is sequentially written to the first capacitor. A second capacitor having: a first electrode connected to a gate terminal of the drive transistor, and to the first electrode of the first capacitor; and a second electrode connected to a control line. The control line is supplied with a pulse signal.

### TECHNICAL FIELD

The disclosure relates to a display device.

### BACKGROUND ART

Patent Document 1 discloses a display device in which each of the pixel circuits includes a light-emitting element.

### CITATION LIST

### Patent Literature

Patent Document 1: US2012/0001896A1

### SUMMARY

### Technical Problem

However, in the known technique, luminance of the light-emitting element decreases in a light-emitting frame period immediately after a non-light-emitting frame period.

### Solution to Problem

A display device according to one aspect of the present disclosure includes: a display unit including a plurality of scanning lines, a plurality of control lines, and a plurality of pixel circuits; and a drive circuit driving the scanning lines and the control lines. Each of the pixel circuits includes: a light-emitting element; a drive transistor disposed in series with the light-emitting element, and controlling an amount of a current flowing in the light-emitting element; a write control transistor having a gate terminal connected to a corresponding one of the plurality of scanning lines; a first capacitor having: a first electrode connected to a gate terminal of the drive transistor and to the write control transistor; and a second electrode connected to a constant potential wire, such that a data signal is sequentially written to the first capacitor; and a second capacitor having: a first electrode connected to the gate terminal of the drive transistor, and to the first electrode of the first capacitor; and a second electrode connected to a corresponding one of the plurality of the control lines. The control lines are supplied with a pulse signal.

### Advantageous Effect of Invention

An aspect of the present disclosure can increase luminance of a light-emitting element in a light-emitting frame period immediately after a non-light-emitting frame period.

### BRIEF DESCRIPTION OF DRAWINGS

FIG. 1 is a schematic diagram illustrating an exemplary configuration of a display device according to an embodiment of the present disclosure.

FIG. 2 is a schematic circuit diagram illustrating an equivalent circuit of an exemplary pixel circuit illustrated in FIG. 1.

FIG. 3 is a schematic diagram illustrating an exemplary behavior of the pixel circuit illustrated in FIG. 2.

FIG. 4 is a schematic diagram illustrating an exemplary configuration of an organic LED.

FIG. 5 is a schematic diagram illustrating exemplary signal potentials supplied to scanning lines illustrated in FIG. 1.

FIG. 6 is a schematic diagram illustrating an exemplary behavior of the pixel circuit illustrated in FIG. 2.

FIG. 7 is a schematic circuit diagram illustrating an equivalent circuit of a pixel circuit in a comparative example.

FIG. 8 is a schematic diagram illustrating an exemplary behavior of the pixel circuit in the comparative example illustrated in FIG. 7.

FIG. 9 is a graph showing a characteristic of a TFT including an n-channel formed of oxide semiconductor.

FIG. 10 is a schematic circuit diagram illustrating a circuit configuration in which the equivalent circuit of the pixel circuit in the comparative example is additionally provided with an equivalent circuit between a gate and a source of a drive transistor DR-T.

FIG. 11 is a schematic diagram illustrating an exemplary behavior of the pixel circuit in the comparative example illustrated in FIG. 10.

FIG. 12 is a schematic circuit diagram illustrating an equivalent circuit of the exemplary pixel circuit illustrated in FIG. 1.

FIG. 13 is a graph showing a characteristic of a TFT including a p-channel formed of oxide semiconductor.

FIG. 14 is a schematic diagram illustrating an exemplary behavior of the pixel circuit illustrated in FIG. 12.

FIG. 15 is a schematic diagram illustrating an equivalent circuit of a pixel circuit according to a comparative example.

FIG. 16 is a schematic circuit diagram illustrating an equivalent circuit of the exemplary pixel circuit illustrated in FIG. 1.

FIG. 17 is a schematic diagram illustrating an exemplary configuration of a display device according to an embodiment of the present disclosure.

FIG. 18 is a schematic circuit diagram illustrating an equivalent circuit of an exemplary pixel circuit illustrated in FIG. 17.

FIG. 19 is a schematic diagram illustrating an exemplary behavior of the pixel circuit illustrated in FIG. 18.

FIG. 20 is a schematic diagram illustrating an exemplary behavior of the pixel circuit illustrated in FIG. 18.

FIG. 21 is a schematic diagram illustrating an exemplary behavior of the pixel circuit illustrated in FIG. 18.

FIG. 22 is a schematic diagram illustrating an exemplary behavior of a pixel circuit in a frame period at a 0 level.

FIG. 23 is a schematic diagram illustrating an exemplary behavior of a pixel circuit in a frame period in a maximum luminance level.

FIG. 24 is a graph showing a relationship between a time period and an APL.

### DESCRIPTION OF EMBODIMENTS

### First Embodiment

### Configuration of Display Device

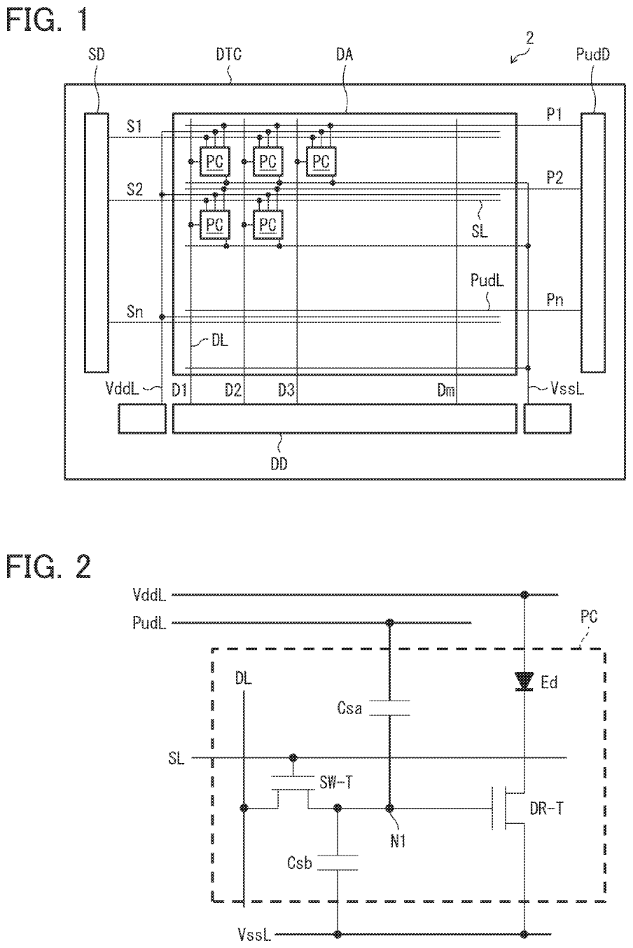

FIG. 1 is a schematic diagram illustrating an exemplary configuration of a display device 2 according to an embodiment of the present disclosure.

As illustrated in FIG. 1, the display device 2 according to this embodiment includes: a display unit DA including n scanning lines SL, n control lines PudL, m data signal lines DL, and m*n pixel circuits PC; a scan driver SD (a drive circuit) that drives the scanning lines SL; a pump up-down driver PudD (a drive circuit) that drives the control lines PudL; a data driver DD that drives the data signal lines DL; a power supply potential wire VddL that supplies a power supply potential Vdd of a pixel current supply source; and a common reference potential wire VssL that supplies a common reference potential Vss of the pixel current supply source.

Here, n is an integer of 2 or more, and m is an integer of 2 or more. Furthermore, the symbol “*” is used as an operator for integration.

The scanning lines SL, which extend in a horizontal direction, are supplied with a scan signal for controlling writing to the pixel circuits PC. A scanning line SL in an i-th stage is connected to an output terminal Si of the scan driver SD. Here, i is an integer of n or less.

The control lines PudL, which extend in the same horizontal direction as the scanning lines SL extend, are supplied with a pulse signal. A control line PudL in the i-th stage is connected to an output terminal Pi of the pump up-down driver PudD.

The data signal lines DL extend vertically, and supply a write data signal to the pixel circuits PC. The data signal lines DL, which intersect perpendicularly with the scanning lines SL and the control lines PudL in plan view, are provided in a layer separate from the scanning lines SL and the control lines PudL. Hence, the data signal lines DL are not connected to either the scanning lines SL or the control lines PudL. A data signal line DL in a j-th row is connected to an output terminal Dj of the data driver DD. Here, j is an integer of m or less.

The power supply potential wire VddL and the common reference potential wire VssL are power lines for supplying a current to light-emitting elements Ed, and are constant potential wires. The common reference potential Vss may be either a GND potential or an earth potential. Hereinafter, the common reference potential Vss is set to 0 V.

The pixel circuits PC are provided in a matrix to correspond to intersections of the scanning lines SL and the data signal lines DL. Each of the pixel circuits PC is connected to a corresponding one of the scanning lines SL, to a corresponding one of the data signal lines DL, and to a corresponding one of the control lines PudL. A pixel circuit PC provided in the i-th stage and the j-th row is connected: through the scanning line SL in the i-th stage to the output terminal Si of the scan driver SD; through the control line PudL in the i-th stage to the output terminal Pi of the pump up-down driver PudD; and through the data signal line DL in the j-th row to the output terminal Dj of the data driver DD.

### Configuration and Behavior of Pixel Circuit

FIG. 2 is a schematic circuit diagram illustrating an equivalent circuit of an exemplary pixel circuit PC illustrated in FIG. 1.

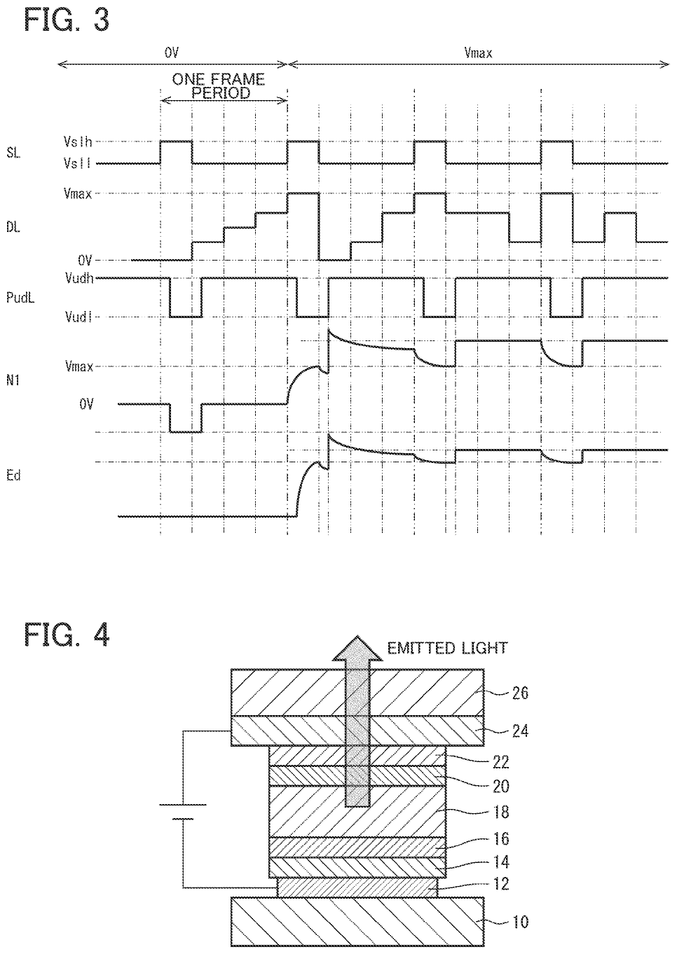

FIG. 3 is a schematic diagram illustrating an exemplary behavior of the pixel circuit PC illustrated in FIG. 2.

As illustrated in FIG. 2, the pixel circuit PC according to this embodiment includes: a light-emitting element Ed; a drive transistor DR-T; a write control transistor SW-T; a first capacitor Csb; and a second capacitor Csa.

The light-emitting element Ed may be either an organic light-emitting diode (OLED) including an organic light-emitting layer, or a quantum-dot diode (QLED) including a quantum-dot light-emitting layer. The light-emitting element Ed is connected between the power supply potential wire VddL and the common reference potential wire VssL.

The drive transistor DR-T is connected, in series with the light-emitting element Ed, between the power supply potential wire VddL and the common reference potential wire VssL. The drive transistor DR-T controls the amount of current flowing in the light-emitting element Ed. The drive transistor DR-T is a thin-film transistor (TFT) having an n-channel.

The write control transistor SW-T has a gate terminal connected to a corresponding scanning line SL. The write control transistor SW-T is connected between a corresponding data signal line DL and a gate terminal of the drive transistor DR-T.

The first capacitor Csb has: a first electrode connected to the gate terminal of the drive transistor DR-T and to the write control transistor SW-T; and a second electrode connected to a constant potential wire. If the drive transistor DR-T is an n-type drive transistor, the second electrode is connected to the power supply potential wire VddL. From the corresponding data signal line DL through the write control transistor SW-T, a data signal is sequentially written to the first capacitor Csb.

The second capacitor Csa has: a first electrode connected to the gate terminal of the drive transistor DR-T, to the write control transistor SW-T, and to the first electrode of the first capacitor Csb; and a second electrode connected to a corresponding control line PudL. From the corresponding data signal line DL through the write control transistor SW-T, a data signal is sequentially written to the second capacitor Csa.

Note that the circuit configuration illustrated in FIG. 2 is solely a minimum circuit configuration necessary for a basic operation of the pixel circuit PC. An actual display device is provided with, for example, an additional transistor for controlling the current, in order to compensate for variations of a circuit element.

As illustrated in FIG. 3, the scanning line SL and the control line PudL are supplied with a pulse signal. The data signal line DL is supplied with a stepwise data voltage. Then, in the pixel circuit PC, the gate terminal of the drive transistor DR-T is connected to a node N1. A potential of the node N1 varies as illustrated in FIG. 3. As a result, luminance of the light-emitting element Ed in the pixel circuit PC varies as illustrated in FIG. 3.

The luminance of light emitted from the light-emitting element Ed is controlled by a current flowing between a source and a drain of the drive transistor DR-T. The current flowing between the source and the drain of the drive transistor DR-T is controlled by a difference in potential between the gate and the source of the drive transistor DR-T. The difference in potential between the gate and the source of the drive transistor DR-T is controlled by charges accumulated in the first capacitor Csb and the second capacitor Csa and by a potential of the control line PudL.

At least once in a frame period FP, a signal potential to be supplied to the scanning line SL is a potential Vslh (referred to as an “ON potential”) that energizes the write control transistor SW-T. At that moment, the charges corresponding to the potential 0 V or Vmax of the data signal line DL are stored in the first capacitor Csb and the second capacitor Csa, and the luminance of the light-emitting element Ed in the frame period is controlled.

### Micro LED Display

The display device 2 may be a micro LED display. In this case, the display device 2 includes: the pixel circuits PC illustrated in FIG. 2 without the light-emitting elements Ed; electrode pads for connecting micro LEDs; the scanning lines SL; the control lines PudL; the data signal lines DL; the power supply potential wire VddL; and the common reference potential wire VssL, all of which are provided on a support substrate. The support substrate is, for example, a glass substrate. The light-emitting elements Ed are externally added to the support substrate to serve as the micro LEDs.

Here, the term “LED” means a light-emitting diode.

### Organic LED Display

The display device 2 may be an organic LED display. In this case, the display device 2 includes: the pixel circuits PC illustrated in FIG. 2 without the light-emitting elements Ed; the scanning lines SL; the control lines PudL; the data signal lines DL; and the power supply potential wire VddL, all of which are provided on a support substrate. Then, on a counter substrate, a transparent electrode is provided to function as the common reference potential wire VssL. Between the support substrate and the counter substrate, organic LEDs are formed.

FIG. 4 is a schematic diagram illustrating an exemplary configuration of an organic LED.

As illustrated in FIG. 4, the organic LED is a multilayer stack including: a cathode 12; an electron injection layer 14; an electron transport layer 16; a light-emitting layer 18; a hole transport layer 20; a hole injection layer 22; and an anode 24, all of which are stacked on top of another above a support substrate 10.

At least one of the cathode 12 or the anode 24 is a transparent electrode. The transparent electrode may be formed of either a transparent conductor such as indium tin oxide (i.e., “ITO”), or a thin film made of an opaque conductor such as a silver alloy.

### Mini LED Backlight

The display device 2 may be a liquid crystal display including a mini LED backlight.

At present, the backlight in widespread use for a liquid crystal display includes, as light sources of the backlight, many small-sized mini LEDs of 1 mm or less on each side. The backlight is driven by local dimming; that is, each of the light sources is divided into a plurality of areas and driven. The number of divided areas is gradually increasing, and has recently exceeded 1000 areas. It is expected that, in the years to come, the number of divided areas will further increase.

Currently, the above-described local dimming LED backlights have a mainstream circuit configuration in which an output of an LED driver is connected to the cathode side of the mini LED for each area. Hence, wires and anode wires as many as the areas are required. Problems of such a circuit configuration are that, the number of wires increases as the number of areas increases. Furthermore, outputs of the LED drivers as many as the areas are required, and the number of LED drivers inevitably increases. Hence, as a technique devised to solve the problems, the local dimming drive is performed by the active matrix in which pixel circuits including TFTs are formed on a glass substrate used for a current liquid crystal panel. In the years to come, if the number of areas exceeds 10,000, the active matrix drive will be a highly potential technique.

In the case of a local dimming LED backlight driven by the active matrix, the backlight includes: the pixel circuits PC illustrated in FIG. 2 without the light-emitting elements Ed; electrode pads for connecting mini LEDs; the scanning lines SL; the control lines PudL; the data signal lines DL; the power supply potential wire VddL; and the common reference potential wire VssL, all of which are provided on a support substrate. The support substrate is, for example, a glass substrate. The light-emitting elements Ed are externally added to the support substrate to serve as the mini LEDs. The light-emitting elements Ed may be a series of two or more LEDs. The two or more LEDs may be connected in parallel, in series, or in a mixture of parallel and series.

### Active Matrix Drive

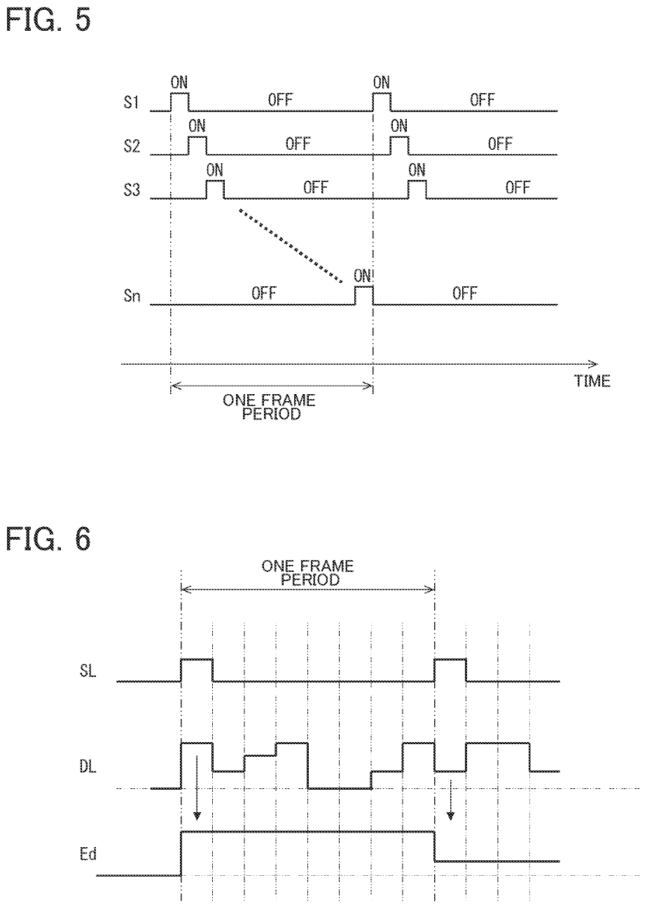

FIG. 5 is a schematic diagram illustrating exemplary signal potentials supplied to scanning lines SL illustrated in FIG. 1.

FIG. 6 is a schematic diagram illustrating an exemplary behavior of the pixel circuit PC illustrated in FIG. 2.

Note that a waveform showing luminance of the light-emitting element Ed in FIG. 6 is solely a simplified one in the form of a stepwise waveform for the sake of simplicity. Furthermore, note that, for the sake of simplicity, FIG. 6 omits phenomena irrelevant to the basic operation of the active matrix drive, such as voltage effects due to current leakage between terminals of each transistor.

The display device 2 is an active-matrix-driven display device.

As illustrated in FIG. 5, in order to cause the light-emitting element Ed of each pixel circuit PC to emit light in accordance with a desired image, a potential (referred to as an “ON potential”) is sequentially supplied to the scanning lines SL to energize the write control transistor SW-T at timings at which a certain time period (referred to as either a “frame period” or a “vertical scanning period”) is divided by n. When a period (referred to as an “ON period”) in which the ON potential is supplied ends, each of the scanning lines SL is supplied with a potential (referred to as an “OFF potential”) to non-energize the write control transistor SW-T.

As illustrated in FIG. 6, while the scanning line SL is in the ON period, each data signal line DL is connected to the corresponding node N1 through the corresponding write control transistor SW-T, and applies a voltage to the corresponding first capacitor Csb and the corresponding second capacitor Csa. The first capacitor Csb and the second capacitor Csa accumulate charges based on the applied voltage. Next, in a period (referred to as an “OFF period”) in which the scanning line SL is supplied with the OFF potential, the first capacitor Csb and the second capacitor Csa hold a voltage (referred to as a “data voltage”) based on the accumulated charges. Then, in accordance with the held data voltage, the current flowing between the source and the drain of the drive transistor DR-T is controlled, and the luminance of light emitted from the light-emitting element Ed is controlled.

### Configuration and Behavior of Comparative Example

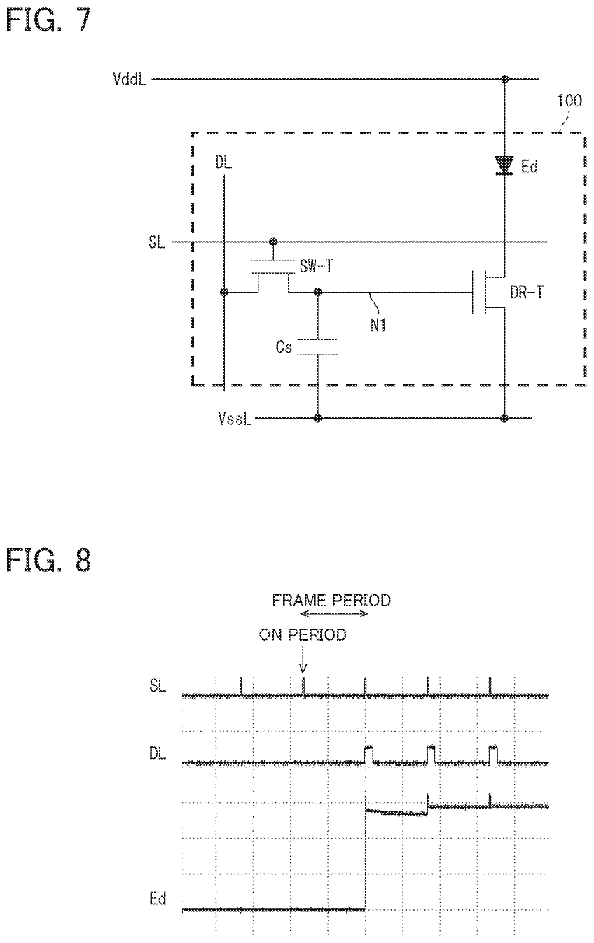

FIG. 7 is a schematic circuit diagram illustrating an equivalent circuit of a pixel circuit 100 in a first comparative example.

FIG. 8 is a schematic diagram illustrating an exemplary behavior of the pixel circuit 100 in the first comparative example illustrated in FIG. 7.

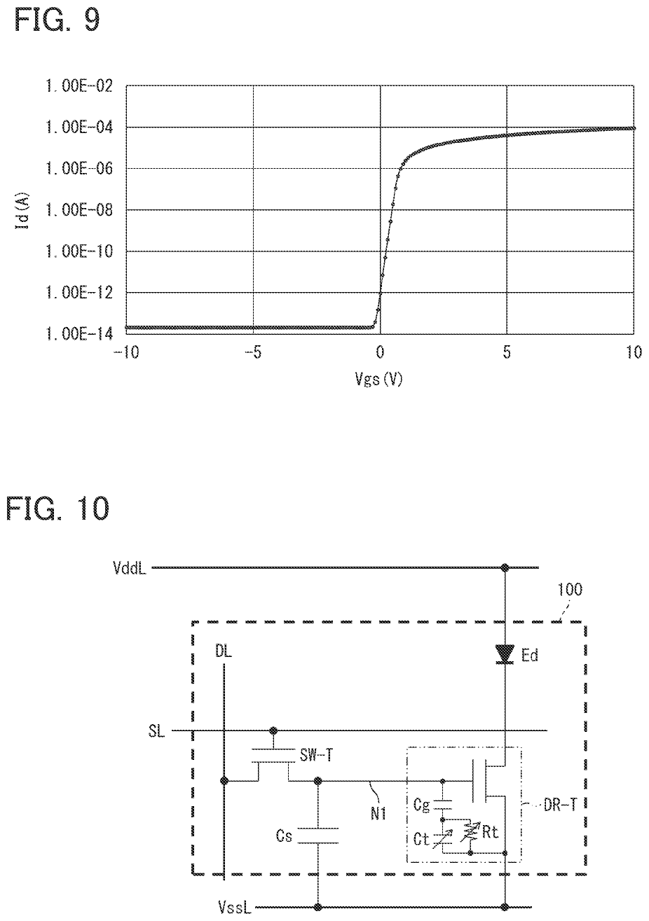

FIG. 9 is a graph showing a characteristic of a TFT including an n-channel formed of oxide semiconductor. In FIG. 9, the vertical axis represents a current Id flowing between the source and the drain of the TFT, and the horizontal axis represents a voltage Vgs between the gate and the source of the TFT.

FIG. 10 is a schematic circuit diagram illustrating a circuit configuration in which the equivalent circuit of the pixel circuit 100 in the first comparative example is additionally provided with an equivalent circuit between a gate and a source of a drive transistor DR-T.

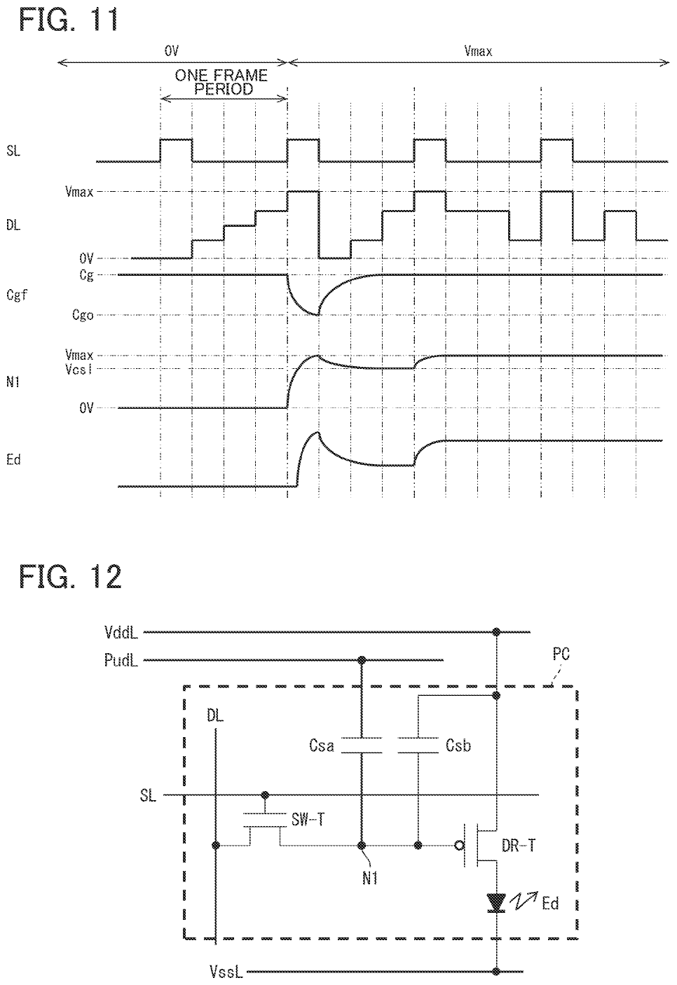

FIG. 11 is a schematic diagram illustrating an exemplary behavior of the pixel circuit 100 in the first comparative example illustrated in FIG. 10.

Note that waveforms illustrated in FIG. 11 are solely simplified ones for the sake of simplicity, and ignore voltage pull-in by the gate terminal of the write control transistor SW-T and parasitic capacitance of circuit elements and wires.

As illustrated in FIG. 7, the pixel circuit 100 of the first comparative example is similar to the pixel circuit PC of the first embodiment except that the pixel circuit 100 is not connected to the control line PudL and includes a storage capacitor Cs instead of the first capacitor Cab and the second capacitor Csa. Note that a capacity of the storage capacitor Cs is equal to a sum of capacities of the first capacitor Cab and the second capacitor Csa.

As illustrated in FIG. 8, a stepwise signal potential is supplied to the scanning line SL and the data signal line DL, so that a dark display for which the light-emitting element Ed does not emit light continues for several frame periods, and after that, the dark display switches to a bright display for which the light-emitting element Ed emits light. Then, variation in luminance of the light-emitting element Ed is measured. In the frame period immediately after the dark display has switched to the bright display, the luminance of the light-emitting element Ed decreases with time. Whereas, in the second and third frame periods after the dark display has switched to the bright display, the luminance of the light-emitting element Ed does not decrease with time.

As a cause of the decrease in luminance, a current leakage between the gate and the source of the drive transistor DR-T has been examined. However, if the current leakage were the cause, the decrease in luminance should be observed also in the second and subsequent frame periods after the switch. Hence, the current leakage is presumed not to be the cause.

As a cause of the decrease in luminance, insufficient charging of the gate electrode of the drive transistor DR-T has also been examined. However, the ON period has been set to have a sufficient length so that the storage capacitor Cs can hold the data voltage until the subsequent frame period. Hence, the insufficient charging is presumed not to be the cause.

A characteristic of the drive transistor DR-T has been examined.

As illustrated in FIG. 9, in a case where the drive transistor DR-T is a TFT including an n-channel formed of, for example, oxide semiconductor such as indium gallium tin oxide, when a voltage Vgs is generated between the gate and the source of the drive transistor DR-T, charges are accumulated in a p-type semiconductor across an insulator from the gate electrode. Then, when a difference in potential between the gate and the source reaches a threshold voltage Vth or more, the current Id flowing between the source and the drain rapidly increases.

If the gate-source voltage Vgs is lower than a flat band voltage, the charges stored in the p-type semiconductor across from the gate electrode are confined in the holes, and a depletion layer is formed. Because the charges cannot move in the depletion layer, a capacitance is formed between the gate and the source of the drive transistor DR-T. Here, unlike the insulator, the depletion layer of the semiconductor has charges. Then, if the gate-source voltage Vgs is higher than, or equal to, the flat band voltage, the depletion layer of the semiconductor changes, and a neutral region and an accumulation region are formed.

Hence, while the gate-source voltage Vgs is between 0 V and a voltage lower than the flat band voltage, the n-channel TFT has, as the gate-source capacitances, a capacitance Cg produced of the insulator between the gate and the source and a capacitance Ct caused by a state of the depletion layer of the semiconductor. The two capacitances Cg and Ct are connected in series. When the gate-source voltage Vgs is higher than, or equal to, the flat band voltage, the state of the depletion layer in the semiconductor gradually changes, and the capacitance Ct caused by the depletion layer gradually disappears.

The time required for changing the state of the depletion layer is longer than the ON period in which the data voltage is written to the storage capacitor Cs. The gate-source voltage Vgs of the drive transistor DR-T is lower than the flat band voltage in the dark display, and higher than, or equal to, the flat band voltage in the bright display. Hence, immediately after the bright display is changed to the dark display, the capacitance Ct caused by the depletion layer has to be taken into consideration. The capacitance Ct caused by the depletion layer varies depending on how the charges distribute because of the state of the depletion layer in the semiconductor. If the voltage Vgs varies from lower than the flat band to the flat band or higher, the state of the depletion layer changes with time. The change in the state of the depletion layer reduces the capacitance Ct. A rate of the change in the state of the depletion layer is estimated to be approximately between sub milliseconds and several milliseconds from the variation of the voltage Vgs to the completion of the state change, depending on a material and composition of the depletion layer.

When the gate-source voltage Vgs is lower than, or equal to, the flat band voltage, the capacitance Ct caused by the depletion layer is obtained by solving the Poisson equation in a simple flat plate capacitor model. Wherein Vb is a voltage to be applied to the semiconductor when the voltage Vgs is applied between the gate and the source, the capacitance Ct is expressed by the following equation. The capacitance Ct varies in proportion to an inverse of a square root of the voltage Vb. Note that Vb=0 is excluded.

If the gate-source voltage Vgs is higher than, or equal to, the flat band voltage, immediately after the voltage Vgs higher than, or equal to, the flat band voltage is applied, the capacitance Ct caused by the depletion layer is found. The capacitance Ct is proportional to the inverse of the square root of the voltage Vb. Then, in the depletion layer, the electrons and the holes are thermally created and destroyed repeatedly. When the voltage Vgs is higher than, or equal to, the flat band voltage, the electrons have lower energy in accumulating at an interface with the insulator than in combining with the holes to form the depletion layer. Hence, the electrons in the depletion layer gradually move to the interface with the insulator, and the depletion layer gradually decreases in thickness. This phenomenon is a transition to a thermal equilibrium state, and takes time from sub milliseconds to several milliseconds. After the transition, the capacitance Ct does not have to be taken into consideration.

As illustrated in FIG. 10, the pixel circuit 100 of the first comparative example additionally includes an equivalent circuit provided between the gate and the source of the drive transistor DR-T. The capacitance Cg is a capacitance produced of the insulator between the gate and the source. The capacitance Ct is a capacitance dependent on a state of the semiconductor. Rt is a resistor representing, in a form of a simple flow of charges, nonlinear dielectric relaxation caused by state transition of the semiconductor. Note that the capacitance Ct and the resistor Rt are not constants but variables that vary in accordance with the gate-source voltage Vgs.

A capacitance Cgf between the gate and the source of the drive transistor DR-T is a combined capacitance produced of the two capacitances Cg and Ct connected together in series.

As illustrated in FIG. 11, a stepwise signal potential is supplied to the scanning line SL and the data signal line DL so that, after the dark display has continued for several frame periods, the dark display changes to the bright display. For the sake of simplicity, voltage pull-in by the gate terminal of the write control transistor SW-T and parasitic capacitances of circuit elements and wires are ignored. Hence, the capacitance Cgf between the gate and the source of the drive transistor DR-T, the potential of the node N1, and the luminance of the light-emitting element Ed vary as illustrated in FIG. 11.

As illustrated in FIG. 11, an ON potential is applied to the scanning line SL every one frame period. During the ON period, the potential of the data signal line DL is held in the storage capacitor Cs. The potential of the node N1 is equal to the potential of the data signal line DL. The potential of the data signal line DL is 0 V in the ON period of the first frame period among the frame periods illustrated in FIG. 11, and is Vmax in the ON period of the second and subsequent frame periods

In a frame period in which the dark display continues and in a frame period in which the bright display continues, the capacitance Cgf between the gate and the source of the drive transistor DR-T is equal to the capacitance Cg produced of the insulator. In a frame period immediately after the dark display has changed to the bright display, the capacitance Cgf varies to Cgo, and gradually returns to Cg.

As the capacitance Cgf returns from Cgo to Cg, a potential Vcs of the node N1 varies from Vmax to Vcsl in the frame period immediately after the dark display has changed to the bright display.

The luminance of light emitted from the light-emitting element Ed is proportional to the current Id between the source and the drain of the drive transistor DR-T. As described above, the drive transistor DR-T has a range in which the current Id significantly varies in accordance with the variation in the gate-source voltage Vgs. Hence, in such a range, the luminance varies significantly even if the gate-source voltage Vgs varies several percent.

Here, if CS=10*Cg, and Cs=*Cgo, Vsc is approximately 92.7% of Vmax. If Vmx is assumed to be 5.0 V, Vcxl is approximately 4.67 V. Hence, even if the storage capacitor Cs is 10 times as large as the capacitance Cg produced of the insulator, the potential of the node N1; that is, the voltage Vgs between the gate and the source of the drive transistor DR-T is estimated to drop by approximately 7%.

Furthermore, in the second and the subsequent frame periods in which the dark display switches to the bright display, the potential Vcs of the node N1 maintains Vmax, and the luminance of light emitted from the light-emitting element Ed is constant. Hence, the cause of the decrease in luminance is presumed to be the variation of capacitance Cgf between the gate and the source of the drive transistor DR-T.

If the cause of the decrease in luminance is the variation in capacitance, the decrease in luminance can be overcome if the storage capacitor Cs is sufficiently large to the degree not to produce the effect of the storage capacitor Cs, and if the is storage capacitor Cs is sufficiently charged. However, in practice, the resolution of the screen is increasingly higher, the pixel area is limited to a small area, and the ON time is limited to a short time. Hence, the storage capacitor Cs cannot be sufficiently increased in size.

As described above, as to a display or a lighting device that controls a current by the active matrix drive, the luminance decreases in the frame period immediately after the dark display switches to the bright display, such that a delay is observed when the luminance is brought to desired luminance. The delay causes a slow response from the dark display to the bright display.

### Comparison Between this Embodiment and Comparative Example

As illustrated in FIG. 2, the pixel circuit PC according to this embodiment includes the second capacitor Csa, and the second electrode of the second capacitor Csa is connected to the corresponding control line PudL. Hence, as illustrated in FIG. 3, when the potential of the control line PudL is raised from a low potential Vudl (a potential in a first level) to a high potential Vudh (a potential in a second level) after the ON period, the potential Vcs of the node N1 is raised through the second capacitance Csa. Wherein, ΔVcs is a range in which the potential Vcs of the node N1 is raised, 2C is a sum of all capacitances connected to the node N1, and Vamp (=Vudh−Vudl) is a potential amplitude of the control line PudL. Here, a relationship of ΔVcs=Csa/ΣC*Vamp holds. The sum EC of the capacitances includes the first capacitance Csb, the second capacitance Csa, and the capacitance Cgf between the gate and the source of the drive transistor DR-T, and additionally includes a parasitic capacitance other than the capacitance between the gate and the source of the drive transistor DR-T.

The gate-source capacitance Cgf varies as described before in the first comparative example, and a relationship of Cgf=Cgo holds immediately after the write for switching the dark display to the bright display, and a relationship of Cgg=Cg holds immediately after the write to continue the bright display. Note that a relationship of Cg>Cgo holds.

Hence, the raised voltage range ΔVcs immediately after the write to change the dark display to the bright display is greater than the raised voltage range ΔVcs immediately after the write to continue the bright display. Such a feature can compensate for, or cancel, the variation in the potential of the node N1 caused by the variation in the capacitance Cgf between the gate and the source of the drive transistor DR-T. Hence, compared with the pixel circuit 100 of the first comparative example, the pixel circuit PC of this embodiment successfully reduces a decrease in the luminance of the light-emitting element Ed in the frame period immediately after the bright display switches to the dark display.

A potential of a pulse signal of the control line PudL rises from the low potential Vudl (the first level) to the high potential Vudh (the second level) at a timing between the end of writing a data signal to the corresponding pixel circuit PC and the start of writing the subsequent data signal. The gate-source capacitance Cgf is Cgo immediately after the write to switch the dark display to the bright display, and gradually returns to Cg. Hence, the potential of the control line PudL is raised desirably immediately after the write to switch the dark display to the bright display. For example, the pulse signal of the control line PudL rises from the low potential Vudl (the first level) to the high potential Vudh (the second level) at a timing desirably in a period between the end of writing the data signal to the corresponding pixel circuit PC and the end of writing the data signal to a pixel circuit PC in a stage subsequent to the corresponding pixel circuit PC.

Wherein Tp is a time period in which the potential of the control line PudL rises from Vudl to Vudh at the end of the ON period of the corresponding pixel circuit PC, the time period Tp is desirably as short as possible. That is, relationships of Tp>0 and Tp≈0 desirably hold.

Whereas, the potential of the pulse signal of the control line PudL falls from the high potential Vudh (the second level) to the low potential Vudl (the first level) at a timing desirably in the ON period in which the data signal is written to the corresponding pixel circuit PC.

### Raised Voltage Range

If the raised voltage range ΔVcs is greater than the threshold voltage Vth of the drive transistor DR-T, the light-emitting element Ed can emit light in the frame period of the dark display. This is because 0 V is written to the first capacitor Csb and the second capacitor Csa in the ON period in the frame period of the dark display, and, when the potential of the control line PudL is raised immediately after the write, the potential Vcs of the node N1 is raised higher than the threshold voltage Vth. Hence, the potential amplitude Vamp of the control line PudL and the rise timing are set so that the raised voltage range ΔVcs is lower than, or equal to, the threshold voltage Vth. In view of efficiency, the raised voltage range ΔVcs is set to a voltage desirably as close as possible to the threshold voltage Vth.

Furthermore, the potential amplitude Vamp of the control line PudL and the rise timing are desirably set so that the average luminance of the light-emitting element Ed in the frame period immediately after the dark display switches to the bright display is equal to the average luminance of the light-emitting element Ed in the frame period in which the bright display continues. Here, the potential supplied from the data signal line DL in the ON period of the frame period immediately after the dark display switches to the bright display is equal to the potential supplied from the data signal line DL in the ON period of the frame period in which the bright display continues.

For example, if relationships of Tp≈0, Csb=Csa=5*Cg, and Cg=Cgo hold, and the sum 2C of capacitances is approximated to be equal to only the sum of the first capacitance Csb, the second capacitance Csa, and the capacitance Cgf between the gate and source of the drive transistor DR-T, a relationship of Vamp=55/25*Vth holds wherein a relationship of A Vcs=Vth holds. Furthermore, if a drop curve of the potential Vcs of the node N1 in the frame period immediately after the dark display switches to the bright display is approximated to a straight line, a relationship of 110/51 Vth=Vmax holds, wherein the average luminance of the light-emitting element Ed in the frame period immediately after the dark display switches to the bright display is equal to the average luminance of the light-emitting element Ed in the frame period in which the bright display continues, and the data voltage supplied from the data signal line DL in the ON period of the both frame periods is Vmax.

Hence, under the above conditions, the drive transistor DR-T may be set so that the data voltage Vmax, which maximizes the current Id flowing between the source and the drain of the drive transistor DR-T, is 2.16 times the threshold voltage Vth. Here, the decrease in luminance is reduced in the frame period immediately after the dark display switches to the bright display.

### Second Embodiment

Another embodiment of the disclosure will be described below. Note that, for convenience in description, like reference signs designate members having identical functions between this embodiment and the above embodiment. These members will not be elaborated upon repeatedly.

FIG. 12 is a schematic circuit diagram illustrating an equivalent circuit of an exemplary pixel circuit PC illustrated in FIG. 1.

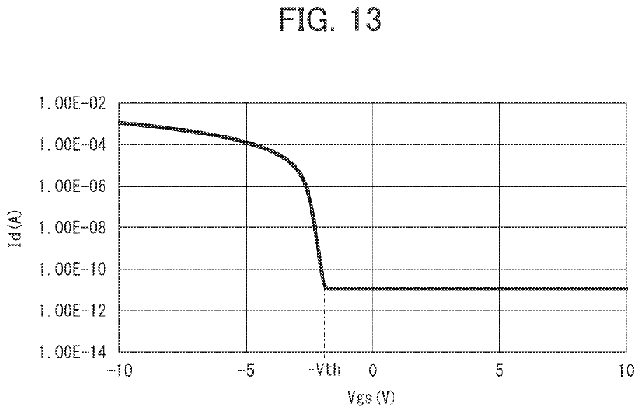

FIG. 13 is a graph showing a characteristic of a TFT including a p-channel formed of oxide semiconductor. In FIG. 13, the vertical axis represents a current Id flowing between the source and the drain of the TFT, and the horizontal axis represents a voltage Vgs between the gate and the source of the TFT.

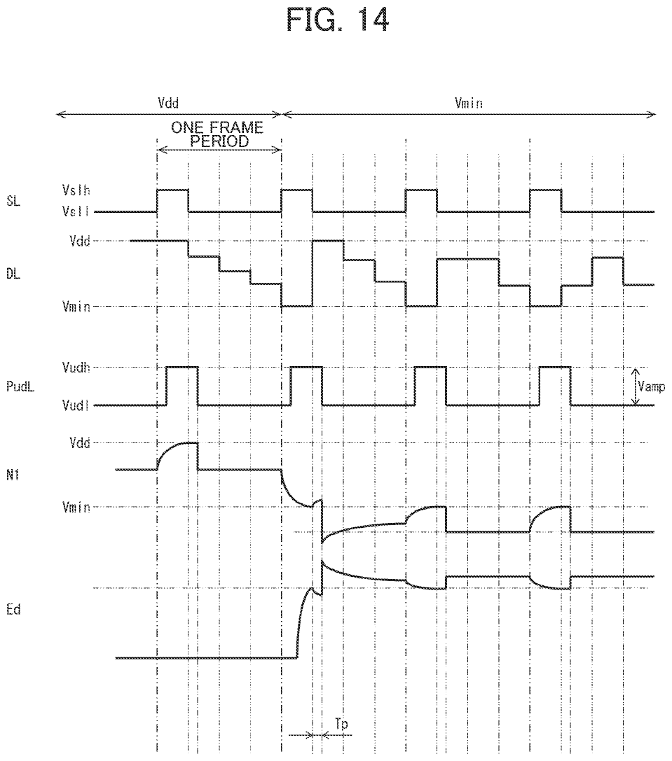

FIG. 14 is a schematic diagram illustrating an exemplary behavior of the pixel circuit PC illustrated in FIG. 12.

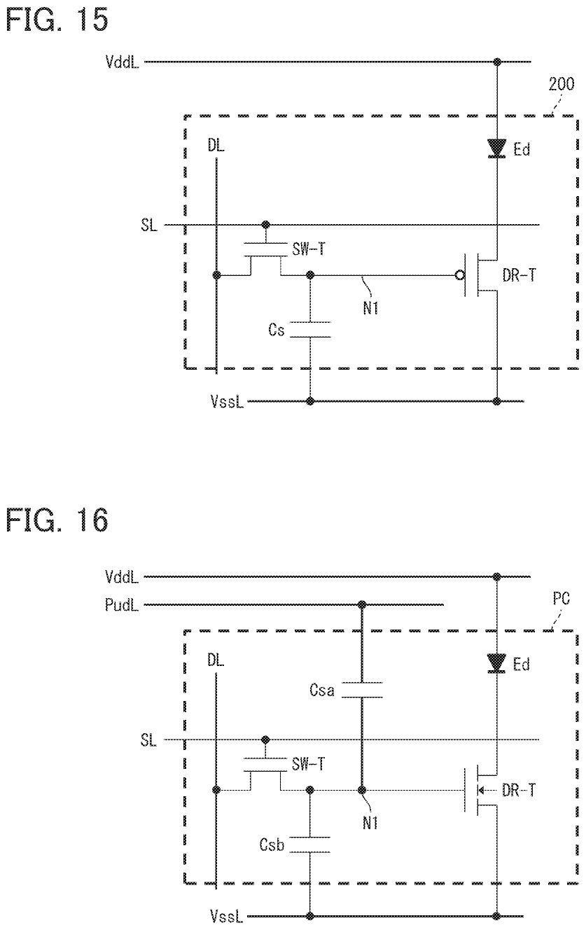

FIG. 15 is a schematic circuit diagram illustrating an equivalent circuit of a pixel circuit 200 according to a second comparative example.

As illustrated in FIG. 12, the pixel circuit PC according to this embodiment is the same as the pixel circuit PC according to the first embodiment except that the drive transistor DR-T is a TFT having a p-channel, and, accordingly, the second electrode of the second capacitor Csa is connected to the common reference potential wire VssL.

As illustrated in FIG. 13, in a case where the drive transistor DR-T is a TFT including a p-channel, the current Id flows between the gate and the source of the drive transistor DR-T if the voltage Vgs is lower than, or equal to, the threshold voltage Vth, and the current Id does not flow if the voltage Vgs is higher than, or equal to the threshold voltage Vth.

As illustrated in FIG. 14, the power supply potential Vdd; that is, a data voltage supplied to the data signal line DL according to this embodiment, is supplied through the power supply potential wire VddL in the dark display. Furthermore, Vmin is a data voltage that maximizes the current Id flowing between the source and drain of the drive transistor DR-T.

As illustrated in FIG. 15, the pixel circuit 200 of the second comparative example is similar to the pixel circuit PC of the second embodiment except that the pixel circuit 200 is not connected to the control line PudL and includes a storage capacitor Cs instead of the first capacitor Cab and the second capacitor Csa. Note that a capacity of the storage capacitor Cs is equal to a sum of capacities of the first capacitor Cab and the second capacitor Csa.

Also, as to the pixel circuit 200 of the second comparative example, similar to the pixel circuit 100 of the first comparative example described before, the luminance of the light-emitting element Ed decreases with time in the frame period immediately after the dark display switches to the bright display.

Whereas, compared with the pixel circuit 200 of the second comparative example, the pixel circuit PC according to this embodiment successfully reduces a decrease in the luminance of the light-emitting element Ed in the frame period immediately after the bright display switches to the dark display.

In this embodiment, wherein Tp is a time period from the end of the ON period of the corresponding pixel circuit PC to a timing at which the potential of the control line PudL falls from the high potential Vudh (the potential in the first level) to the low potential Vudl (the potential in the second level), the time period Tp is desirably as short as possible. That is, relationships of Tp>0 and Tp≈0 desirably hold. Whereas, the potential of the control line PudL is raised from Vuld to Vudh desirably at a timing in the ON period of the corresponding pixel circuit PC.

Furthermore, when the potential of the control line PudL falls from Vudh to Vudl, ΔVcs is determined as a voltage range in which the potential Vcs of the node N1 is dropped. Hence, the potential amplitude Vamp of the control line PudL and rise and drop timings are set so that the dropped voltage range ΔVcs is lower than, or equal to, an absolute value of the threshold voltage Vth. In view of efficiency, the dropped voltage range ΔVcs is set to a voltage desirably as close as possible to the threshold voltage Vth.

As described above, parameters are set in the same manner as in the first embodiment, taking into account that the magnitude relationship of the voltages related to the drive transistor DR-T is inverted.

### Third Embodiment

Still another embodiment of the disclosure will be described below. Note that, for convenience in description, like reference signs designate members having identical functions between this embodiment and the above embodiments. These members will not be elaborated upon repeatedly.

FIG. 16 is a schematic circuit diagram illustrating an equivalent circuit of an exemplary pixel circuit PC illustrated in FIG. 1.

As illustrated in FIG. 12, the pixel circuit PC according to this embodiment is the same as the pixel circuit PC according to the first embodiment except that the drive transistor DR-T is a metal-oxide semiconductor field-effect transistor (MOSFET).

The MOSFET is formed separately from the support substrate. Hence, provided on the support substrate is an electrode pad for connecting the drive transistor DR-T instead of the drive transistor DR-T. The drive transistor DR-T is externally added to the support substrate.

Also, in a case where the MOSFET is used as the drive transistor DR-T, similar to the case where the TFT is used, the pixel circuits 100 and 200 of the first and second comparative examples show a decrease in luminance in the frame period immediately after the dark display switches to the bright display.

The TFT and the MOSFET have different mechanisms in producing a depletion layer in semiconductor lower than, or equal to, the flat band voltage. However, the MOSFET as well as the TFT exhibits the change in the condition of the depletion layer in the semiconductor with respect to transition of the gate voltage from below the flat band voltage to the flat band voltage and above, which is a cause of the decrease in luminance.

Hence, even though variations are observed in such parameters as an absolute amount of current, the pixel circuit PC according to this embodiment shows the same behavior as that of the pixel circuit PC according to the first embodiment.

### Fourth Embodiment

Yet still another embodiment of the disclosure will be described below. Note that, for convenience in description, like reference signs designate members having identical functions between this embodiment and the above embodiments. These members will not be elaborated upon repeatedly.

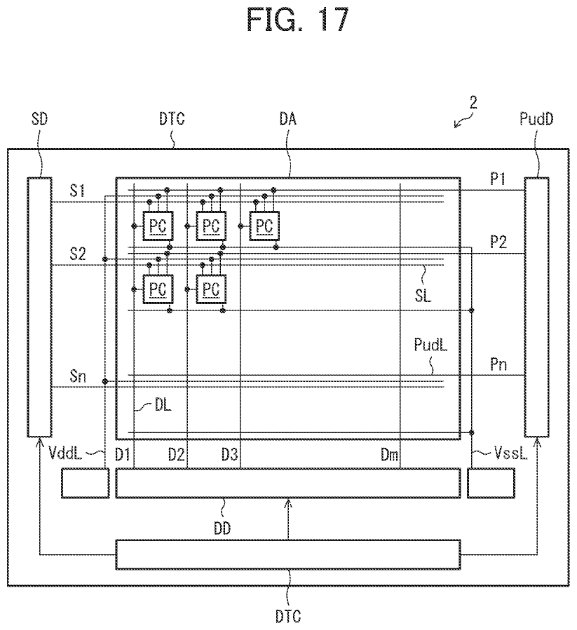

Configuration of Display Device FIG. 17 is a schematic diagram illustrating an exemplary configuration of the display device 2 according to an embodiment of the present disclosure.

As illustrated in FIG. 17, the display device 2 according to this embodiment has the same configuration as that of the display device 2 according to any one of the first to third embodiments, and additionally includes a data timing control unit DTC.

The data timing control unit DTC sends the data driver DD a Data signal indicating an image in each frame period and a Dtim signal indicating a data transfer timing. The data timing control unit DTC sends the scan driver SD an SST signal indicating the start of scanning, an SON signal indicating the ON period, and an SShift signal indicating a timing shift of an output. The data timing control unit DTC sends the pump up-down driver PudD a PUST signal indicating a raise output start timing, a PDST signal indicating a fall output start timing, and a Pshift signal indicating a timing shift of an output.

The data driver DD also receives several reference voltages. With reference to a reference voltage, the data driver DD outputs a data voltage corresponding to the Data signal from each of the output terminals D1 to Dm to a corresponding one of the data signal lines DL at a timing corresponding to the Dtim signal.

The scan driver SD also receives an ON voltage Son and an OFF voltage Soff. The scan driver SD outputs the ON voltage Son from the output terminal S1 in the first stage to the scanning line SL, in a period corresponding to the SON signal at a timing corresponding to the SST signal. After that, the scan driver SD outputs the OFF voltage Soff. The scan driver SD outputs the ON voltage Son from the output terminal S2 in the second stage to the scanning line SL in a period corresponding to the SON signal at a timing shifted corresponding to the Sshift signal from the the timing corresponding to the SST signal. After that, the scan driver SD outputs the OFF voltage Soff. The scan driver SD similarly outputs the ON voltage Son from the output terminals S1 to Sn in the respective stages to a corresponding one of the scanning lines SL at sequentially shifted timings.

The pump up-down driver PudD individually receives the high potential Vudh and the low potential Vudl. From the output terminal P1 in the first stage to the control line PudL, the pump up-down driver PudD outputs: the high potential Vudh from the timing indicated by the PUST signal to the timing indicated by the PDST signal; and the low potential Vudl from the timing indicated by the PDST signal to the timing indicated by the PUST signal. From the output terminals P1 to Pn in the respective stages to the corresponding control lines PudL, the pump up-down driver PudD outputs either the high potential Vudh or the low potential Vudl to sequentially shift timings in accordance with the Pshift signal.

### Configuration of Pixel Circuit

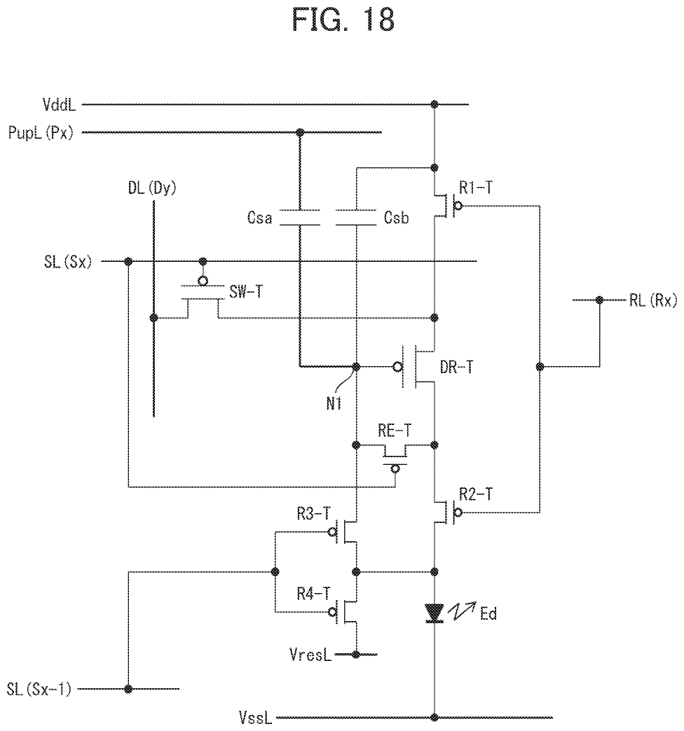

FIG. 18 is a schematic circuit diagram illustrating an equivalent circuit of an exemplary pixel circuit PC illustrated in FIG. 17. FIG. 18 illustrates a pixel circuit PC in the x-th stage and the y-th row.

Described below will be a configuration in which the drive transistor DR-T is a TFT having a p-channel. However, a configuration in which the drive transistor DR-T is either a TFT having an n-channel or a MOSFET is also included in the scope of this embodiment.

The pixel circuit PC according to this embodiment is similar to the pixel circuits PC according to the first to third embodiments except that the former pixel circuit PC includes an internal compensation circuit that compensates for variations in the threshold voltage Vth of the drive transistor DR-T.

As illustrated in FIG. 18, the pixel circuit PC according to this embodiment is the pixel circuit PC according to any one of the first to third embodiments incorporating the internal compensation circuit including: a pair of cut-off transistors R1-T and R2-T; a pair of voltage initializing transistors R3-T and R4-T; and a compensation transistor RE-T.

The cut-off transistors R1-T and R2-T are arranged to cut off the drive transistor DR-T from a current path passing through the light-emitting element Ed connected between the power supply potential line VddL and the common reference potential line VssL. In the pixel circuit PC in the i-th stage, each of the cut-off transistors R1-T and R2-T has a gate terminal connected through the light-emission control line RL to an output terminal Ri in the i-th stage.

The voltage initializing transistors R3-T and R4-T are arranged to connect the first electrode of the first capacitor Csb and the first electrode of the second capacitor Csa to a reset voltage line VresL that supplies a constant voltage. In the pixel circuit PC in the i-th stage, each of the voltage initializing transistors R3-T and R4-T has a gate terminal connected to an output terminal S(i−1), similar to the scanning line SL in the (i−1)-th stage.

The compensation transistor RE-T is disposed between the source terminal and the gate terminal of the drive transistor DR-T, and connects the source terminal and the gate terminal together. Alternatively, the compensation transistor RE-T may be disposed between the drain terminal and the gate terminal of the drive transistor DR-T, and connect the drain terminal and the gate terminal together. In the pixel circuit PC in the i-th stage, the compensation transistor RE-T has a gate terminal connected through the scanning line SL in the i-th stage to the output terminal Si.

The data signal of the data signal line DL is written through the drive transistor DR-T and the compensation transistor RE-T to the first capacitor Csb and the second capacitor Csa, in order to compensate for the variation in the threshold voltage Vth of the drive transistor DR-T. Note that, during the writing of the data signal, the cut-off transistors R1-T and R2-T cut the drive transistor DR-T off from the current path passing through the light-emitting element Ed. As a result, the light-emitting element Ed does not emit light.

### Configuration of Pixel Circuit

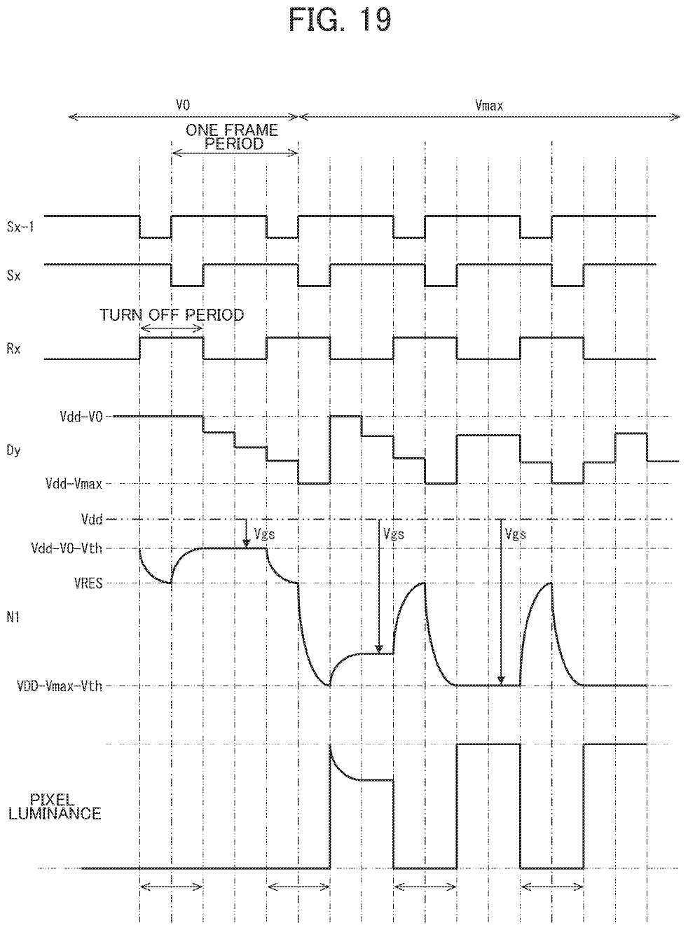

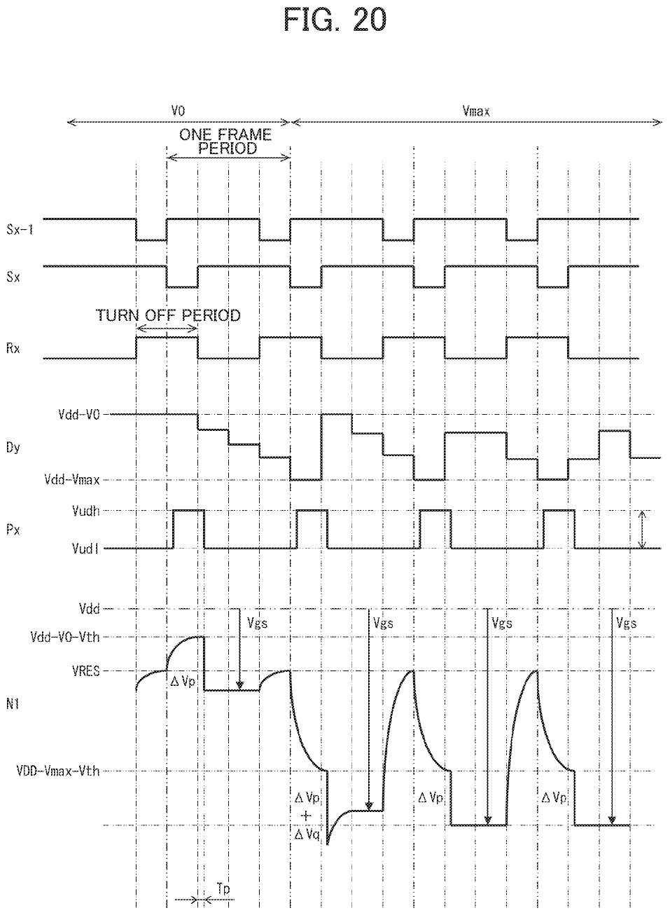

FIGS. 19 to 21 are schematic diagrams illustrating exemplary behaviors of the pixel circuit PC in the x-th stage and the y-th row illustrated in FIG. 18. In each of FIGS. 19 to 21, the pixel circuit PC in the x-th stage and the y-th row is in a state of the dark display in the first frame period and several frame periods preceding the first frame period. In the second frame period and several frame periods following the second frame period, the pixel circuit PC in the x-th stage and the y-th row is in a state of the bright display at the maximum luminance level.

FIG. 19 illustrates a behavior observed when a constant potential is supplied to the control line PudL.

As illustrated in FIG. 19, during a period in which an output terminal Sx−1 for the scanning line SL in the (x−1)-th stage supplies the ON voltage Son, the potential Vcs of the node N1 of the pixel circuit PC in the x-th stage is reset to the voltage Vres of the reset voltage line VresL. This period is referred to either as a “reset period” or as an “x-th stage reset period”.

Furthermore, during a period in which an output terminal Sx for the scanning line SL in the x-th stage supplies the ON voltage Son, a voltage based on a data voltage is written to the first capacitor Csb and the second capacitor Csa of the pixel circuit PC in the x-th stage and the y-th row. This period is referred to either as a “write period” or as an “x-th stage write period”.

During a period between the x-stage reset period and the x-stage write period, an output terminal Rx for a light-emission control line RLL in the x-th stage supplies the OFF voltage, and the light-emitting element Ed of the pixel circuit PC in the x-th stage turns OFF. This period is referred to either as a “turn OFF period” or as an “x-th stage turn OFF period”.

In a frame period of the dark display, an output terminal Dy outputs a data voltage Vdd−V0 to the pixel circuit PC. Because the data voltage is written through the drive transistor DR-T to the first capacitor Csb and the second capacitor Csa, the voltage to be written falls below the data voltage by the threshold voltage Vth of the drive transistor DR-T. Hence, here, wherein |Vgs| is an absolute value of a difference in potential between the gate and the source of the drive transistor DR-T, a relationship of |Vgs|=V0+Vth holds. Since a relationship of V0≈0 V holds, the light-emitting element Ed emits substantially no light.

In a frame period of the bright display at the maximum luminance level, the output terminal Dy outputs a data voltage Vdd-Vmax to the pixel circuit PC. Thus, the voltage to be written falls below the data voltage by the threshold voltage Vth of the drive transistor DR-T, and, wherein |Vgs| is an absolute value of a difference in potential between the gate and the source of the drive transistor DR-T, a relationship of |Vgs|=Vmax+Vth holds.

The second frame period is a frame period in which the luminance level transits from a substantially no-light emission level to a high-level luminance. That is, in the second frame period, the state of the semiconductor in the drive transistor DR-T shifts, so that the absolute value |Vgs| of the difference in the gate-source potential falls after the write period, the potential Vcs of the node N1 rises, and the luminance of the light-emitting element Ed decreases.

The third and fourth frame periods are frame periods in which the high-level luminance continues. That is, in the third and fourth frame periods, the semiconductor in the drive transistor DR-T is in an equilibrium state, and after the write period, the absolute value |Vgs| of the difference in the gate-source potential does not fall. Hence, the luminance of the light-emitting element Ed is substantially constant.

As can be seen, when the control line PudL is supplied with a constant potential, the transition from the low-level luminance to the high-level luminance reduces the luminance of the light-emitting element Ed only in the first frame period. As a result, the response of the display is delayed.

FIG. 20 illustrates a behavior observed when a pulse signal is supplied to the control line PudL.

As illustrated in FIG. 20, a signal potential output from an output terminal Px to the control line PudL in the x-th stage shifts from the low potential Vudl to the high potential Vudh in the write period. After the write period ends, the signal potential shifts from the high potential Vudh to the low potential Vudl. This transition of the potential of the control line PudL is similar to the transition of the potential of the control line PudL in the second embodiment described before.

In the first frame period after the luminance has varied (i.e., the second frame period in FIG. 20), the potential Vcs of the node N1 drops further because of the fall of the potential of the control line PudL. As a result, the average luminance of the light-emitting element Ed increases even if the potential Vcs of the node N1 rises because of the transition of the state of the semiconductor. Hence, similar to the second embodiment, the voltage can be adjusted so that the average luminance is the same between the frame periods. Such a feature improves the display response observed when the luminance transits from the low-level luminance to the high-level luminance.

On the other hand, the pixel circuit PC according to this embodiment incorporates a circuit that compensates for the threshold voltage Vth. Hence, when the pixel circuit PC according to this embodiment is driven in the same manner as the pixel circuit PC according to the second embodiment, it is difficult to set the absolute value |Vgs|, of the difference in the potential between the gate and the source of the drive transistor DR-T, less than, or equal to, an absolute value of the threshold voltage Vth. That is, it is difficult to set the luminance to 0 at the 0 level.

Attention is paid to the transition of the potential Vcs of the node N1 in the first frame period of FIG. 20. In the write period of the first frame period, the potential Vcs becomes Vdd-V0−Vth because of the write. After that, at a timing when the potential of the control line PudL drops from Vudh to Vudl, the potential Vcs of the node N1 becomes Vdd−V0−Vth−ΔVp. Hence, a relationship of V0˜−ΔVp desirably holds.

The data voltage Vdd−V0 corresponds to the 0 level. When the relationship of V0≈−ΔVp holds, a relationship of Vdd−V0=Vdd+ΔVp holds. Hence, as the data voltage corresponding to the 0 level, the data driver DD has to output a voltage exceeding the power supply potential Vdd of the pixel current supply source. Such setting could be impossible, depending on a withstand voltage of the data driver DD.

When the luminance is not zero at the 0 level, a black pixel appears white.

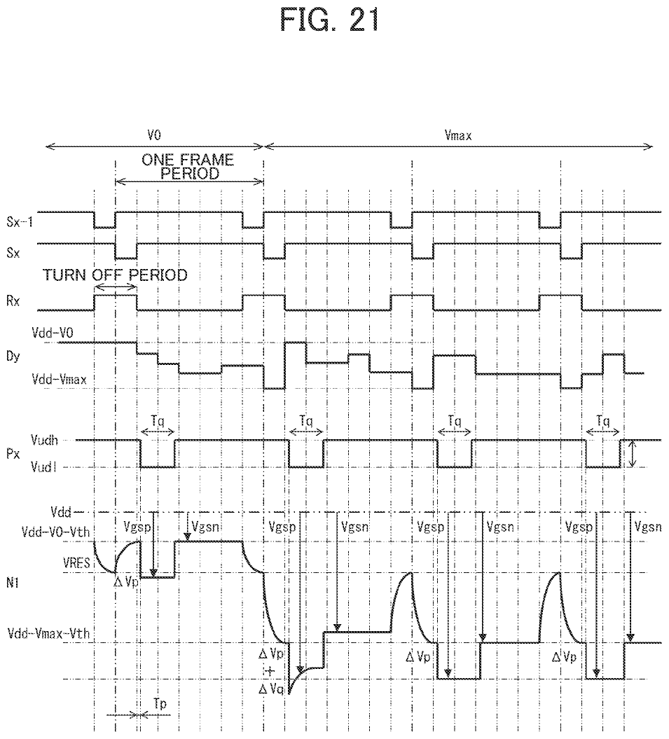

FIG. 21 illustrates a behavior observed when another pulse signal is supplied to the control line PudL.

As illustrated in FIG. 21, the potential of the pulse signal output from the output terminal Px to the control line PudL in the x-th stage maintains the high potential Vudh (the first level) in the write period of the data signal in the x-th stage. After the time period Tp has passed since the end of the write period in the x-th stage, the potential shifts from the high potential Vudh (the first level) to the low potential Vudl (the second level). The potential of the pulse signal output from the output terminal Px shifts from the high potential Vudh (the first level) to the low potential (the second level). After that, by the time when a write period for a subsequent data signal in the x-th stage starts, the potential of the pulse signal shifts from the low potential Vudl (the second level) to the high potential (the first level).

Here, a time period Tq is a time period in which the pulse signal shifting to the low potential Vudl (the second level) is brought back to the high potential Vudh (the first level). The time period Tq is desirably longer than, or equal to, a time period required when the state of the semiconductor of the drive transistor DR-T transits to an equilibrium state. The time required for transition to the equilibrium state depends on a material, an impurity concentration, and a temperature of the semiconductor. The time period is estimated to be approximately several milliseconds.

The pulse signal to be output to the control line PudL is set in the above manner, so that the whitish appearance of the black pixel is reduced.

In the case of the 0 level, Vdd−V0−Vth is written to the potential Vcs of the node N1 in the write period. When the potential of the control line PudL falls from the high potential Vudh to the low potential Vudl, the capacitive coupling of the second capacitance Csa drops the potential Vcs of the node N1 to Vdd−V0−Vth−ΔVp. Here, as to an absolute value of the voltage Vgs between the gate and the source of the drive transistor DR-T, a relationship of |Vgs|=|V0+Vth+ΔVp| holds. Hence, when the potential of the control line PudL rises from the low potential Vudl to the high potential Vudh after the time period Tq, the capacitive coupling of the second capacitance Csa raises the potential Vcs of the node N1 to Vdd−V0−Vth. Here, as to an absolute value of the voltage Vgs between the gate and the source of the drive transistor DR-T, a relationship of |Vgs|=|V0+Vth| holds. When a relationship of V0≈0 holds, a relationship of |Vgs|≈|Vth| holds.

That is, in the frame period at the 0 level, the luminance is 0 after the time period Tq. As a result, the whitish appearance of the black pixel is reduced.

Furthermore, in the first frame period after the luminance has varied (i.e., the second frame period in FIG. 21), the range in which the potential Vcs of the node N1 is dropped after the time period Tp is larger by ΔVq than the range in which the potential Vcs of the node N1 is raised after the time point Tq. Hence, similar to the first to third embodiments, such a feature improves the display response observed when the luminance transits from the low-level luminance to the high-level luminance.

Note that, in the first to third embodiments, the potential Vcs of the node N1 is only dropped (or only raised) between the write period and the subsequent write period; whereas, in this embodiment, the potential Vcs of the node N1 is both dropped and raised. In consideration of such a feature, the potential amplitude Vamp (=Vudh−Vudl) of the control line PudL is set.

### Period

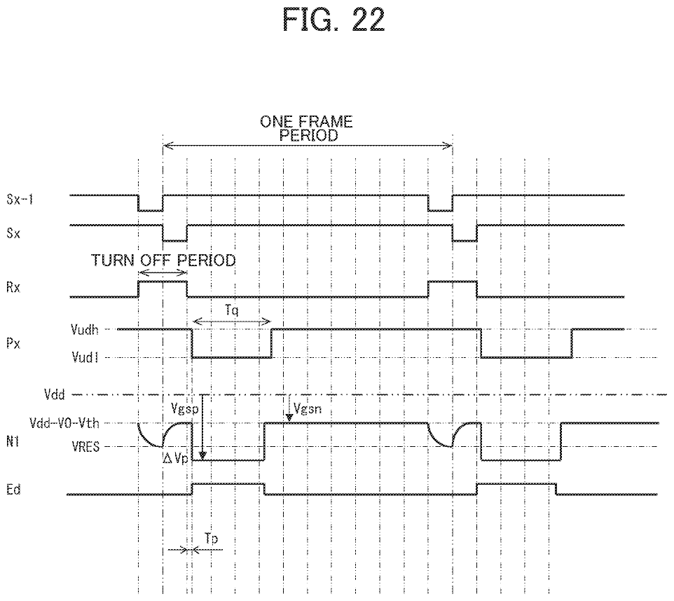

FIG. 22 is a schematic diagram illustrating an exemplary behavior of a pixel circuit PC in a frame period at the 0 level.

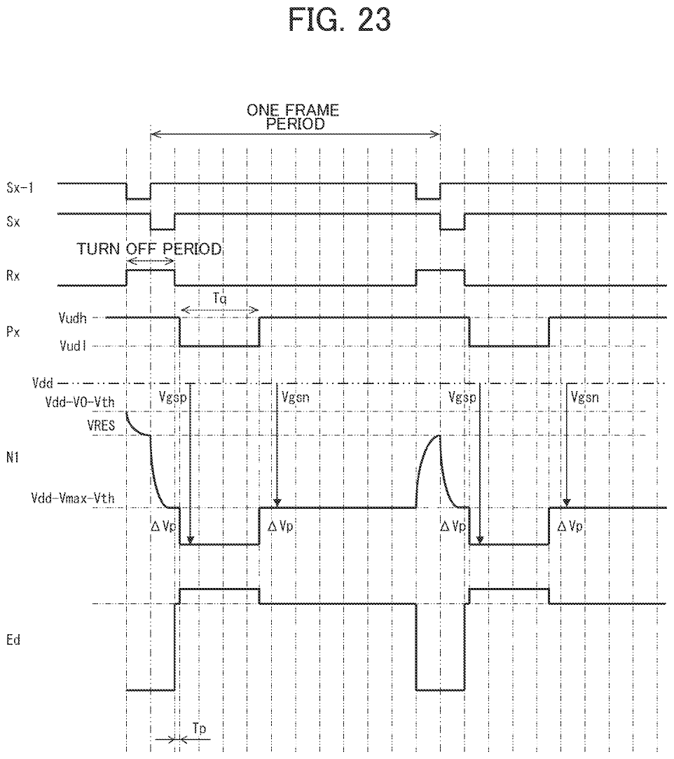

FIG. 23 is a schematic diagram illustrating an exemplary behavior of a pixel circuit PC in a frame period at a maximum luminance level.

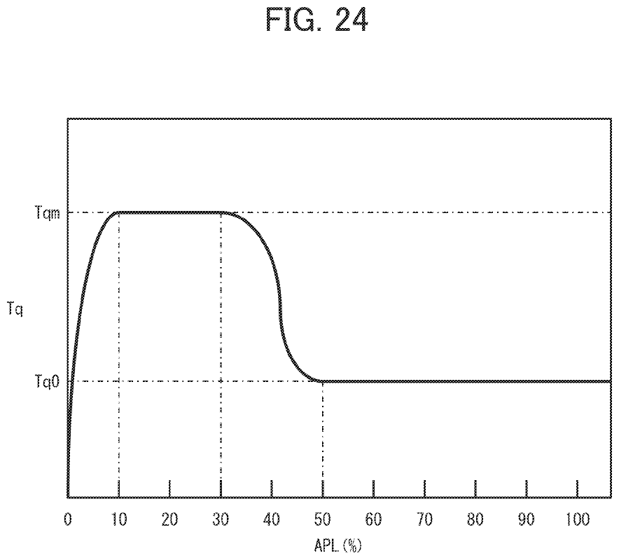

FIG. 24 is a graph showing a relationship between the time period Tp and an average Picture Level (APL).

The APL indicates a ratio of the total number of levels for all the pixels when a certain image is displayed to the total number of levels for all the pixels when all the pixels are at the maximum level. The number of levels is a data voltage that the data driver DD inputs to the pixel circuit PC from the output terminals D1 to Dm through the data signal lines DL. That is, the APL is calculated by the following equation.

$$APL = ( {\sum }_{i = 1}^{n} {\sum }_{j = 1}^{m} Di , j ) / ( Dmax * m * n ) * 100 \% \qquad [ Math . 1 ]$$

Wherein, Di, j is a data voltage to be input to the pixel circuit PC in the i-th stage and the j-th row when a certain image is displayed. Dmax is a data voltage to be input to the pixel circuit PC when the pixel circuit PC causes the light-emitting element Ed to emit light at the maximum luminance level. The symbol 2 is used as symbol for sum.

As described before, n is the number of the scanning lines SL and an integer or two or more, and m is the number of the data signal lines DL and an integer of two or more. The symbol “*” is used as an operator for integration.

The above description shows a case where the length of the time period Tp is fixed. However, a pulse width corresponding to the length of the time period Tp may be set in accordance with the image to be displayed. That is, the pulse width of the pulse signal of the control line PudL may be set in accordance with image data and a data signal to be input.

In this embodiment, the drive transistor DR-T having a p-channel drops the potential of the control line PudL from the high potential Vudh to the low potential Vudl after the time period Tp of the write period, and further raises the potential of the control line PudL from the low potential Vudl to the high potential Vudh after the time period Tq.

As illustrated in FIG. 22, because of the transition of the potential in the frame period at the 0 level, the light-emitting element Ed emits light, though slightly, during the time period Tq in which the potential of the control line PudL is the low potential Vudl. Hence, a black pixel appears white.

As illustrated in FIG. 23, because of the transition of the potential in a frame period at a high-level luminance, the luminance of the light-emitting element Ed increases only for the fall of the potential Vcs of the node N1 in the time period Tq during which the potential of the control line PudL is the low potential Vudl. After that, when the potential of the control line PudL is brought back to the high potential Vudh, the luminance of the light-emitting element Ed decreases only for the raise of the potential Vcs of the node N1. Hence, the light-emitting element Ed according to this embodiment is lower in average luminance in a frame period at the same level than the pixel circuit PC according to the second embodiment. Furthermore, the longer the time period Tq is, the higher the average luminance of the light-emitting element Ed is.

That is, the image quality is higher as the time period Tq is shorter for the dark display and longer for the high luminance display. For example, a pulse width corresponding to the time period Tq for displaying a first image is desirably longer than a pulse width corresponding to the time period Tq for displaying a second image darker than the first image.

As can be seen, in this embodiment, the length of the time period Tq changes in accordance with an input image. Such a feature can reduce whitish appearance of a black pixel, and increase the maximum luminance.

As illustrated in FIG. 24, for example, the length of time period Tq may be controlled in accordance with the APL.

Wherein Tq0 is a length of Tq beneficial for improvement in display response observed in transition from low-level luminance to high-level luminance, a relationship of Tq=Tq0 holds in normal display.

In a case of an all-black screen, a relationship of Tq=0 ms holds. When the APL is 10% to 30%, a relationship of Tq=TFP−TWP holds so that the peak luminance increases. Here, TFP represents a length of one frame period, and TWP represents a length of the write period. A relationship of TFP−TWP=Tqm holds.

In the other cases, Tq is controlled so that a relationship of Tq=Tq0 holds. However, a rapid change of Tq causes a display failure, such that Tq is changed smoothly as illustrated in FIG. 24. Such a change can make black appear darker, the peak luminance produced brighter, and image quality of the display device 2 higher.

Furthermore, for example, the length of the time period Tq may be controlled in accordance with the average luminance level (ALL). The genre of an image to be displayed may be identified by the ALL, and the length of the time period Tq may be controlled in accordance with the genre.

The ALL indicates a ratio of the sum of display luminance values for all the pixels when a certain image is displayed to the sum of display luminance values for all the pixels when all the pixels are at the maximum level. A display luminance value is a luminance value observed when the pixel circuit PC causes the light-emitting element Ed to emit light in response to a data voltage that the data driver DD inputs to the pixel circuit PC. That is, the ALL is calculated by the following equation.

$$ALL = ( {\sum }_{i = 1}^{n} {\sum }_{j = 1}^{m} Li , j ) / ( Lmax * m * n ) * 100 \% \qquad [ Math . 2 ]$$

Wherein, Li, j is a luminance value of the light-emitting element Ed connected to the pixel circuit PC in the i-th stage and the j-th row when a certain image is displayed. Lmax is a luminance value of the light-emitting element Ed when the pixel circuit PC causes the light-emitting element Ed to emit light at the maximum luminance level. The symbol Σ is used as symbol for sum.

The disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the disclosure. Moreover, the technical aspects disclosed in each embodiment may be combined to achieve a new technical feature.

1. A display device, comprising:
a display unit including a plurality of scanning lines, a plurality of control lines, and a plurality of pixel circuits; and
a drive circuit configured to drive the scanning lines and the control lines,
wherein each of the pixel circuits includes:
a light-emitting element;
a drive transistor disposed in series with the light-emitting element, and configured to control an amount of a current flowing in the light-emitting element;
a write control transistor having a gate terminal connected to a corresponding one of the plurality of scanning lines;
a first capacitor having: a first electrode connected to a gate terminal of the drive transistor and to the write control transistor; and a second electrode connected to a constant potential wire, such that a data signal is sequentially written to the first capacitor; and
a second capacitor having: a first electrode connected to the gate terminal of the drive transistor, and to the first electrode of the first capacitor; and a second electrode connected to a corresponding one of the plurality of the control lines, and
the control lines are supplied with a pulse signal.

2. The display device according to claim 1,
wherein, between an end of writing a data signal and a start of writing a subsequent data signal, the pulse signal shifts from a first level to a second level.

3. The display device according to claim 2,
wherein, in a period between an end of writing to the pixel circuit and an end of writing to a pixel circuit in a subsequent stage, the pulse signal shifts from the first level to the second level.

4. The display device according to claim 2,
wherein, after the writing of the data signal starts, the pulse signal shifts from the second level to the first level.

5. The display device according to claim 1,
wherein, during the writing of the data signal, the pulse signal maintains a first level,
after the writing of the data signal ends, the pulse signal shifts from the first level to a second level, and
after the pulse signal shifts from the first level to the second level, by a time when writing of a subsequent data signal starts, the pulse signal shifts from the second level to the first level.

6. The display device according to claim 5,
wherein each of the pixel circuits includes an internal compensation circuit configured to compensate for a threshold voltage of the drive transistor.

7. The display device according to claim 6,
wherein a pulse width, corresponding to a time period in which the pulse signal shifting to the second level is brought back to the first level, is set in accordance with an image to be displayed.

8. The display device according to claim 7,
wherein the pulse width is set in accordance with image data to be input.

9. The display device according to claim 7,
wherein the pulse width for displaying a first image is set longer than the pulse width for displaying a second image darker than the first image.

10. The display device according to claim 6,
wherein the internal compensation circuit includes a compensation transistor, and
either the gate terminal and a drain terminal of the drive transistor, or the gate terminal and a source terminal of the drive transistor, are connected together through the compensation transistor.

11. The display device according to claim 1,
wherein, the light-emitting element does not emit light during the writing of the data signal.

12. The display device according to claim 1,
wherein the plurality of control lines and the plurality of scanning lines extend in a same direction.

13. The display device according to claim 2,
wherein a difference between a potential in the first level and a potential in the second level is lower than, or equal to, a threshold voltage of the drive transistor.

14. The display device according to claim 1, further comprising
a plurality of data signal lines supplied with a data signal,
wherein the write control transistor is connected between a corresponding one of the plurality of data signal lines and the drive transistor.

15. The display device according to claim 2,
wherein the drive transistor has an n-channel, and a potential at the second level is higher than a potential at the first level.

16. The display device according to claim 2,
wherein the drive transistor has a p-channel, and a potential at the second level is lower than a potential at the first level.

17. The display device according to claim 1,
wherein the light-emitting element includes either an organic light-emitting layer or a quantum-dot light-emitting layer.
